(19) United States
(12) Patent Application Publication
(10) Pub. No.: US 2022/0159665 A1
(43) Pub. Date: May 19, 2022

(54) WIRELESS COMMUNICATION METHOD, BASE STATION DEVICE AND BASE STATION SYSTEM

(71) Applicant: INSTITUTE FOR INFORMATION INDUSTRY, TAIPEI (TW)

(72) Inventors: Li-Sheng CHEN, Taipei (TW); Keng-Wei HSU, Taipei (TW)

(21) Appl. No.: 17/113,126

(22) Filed: Dec. 7, 2020

(30) Foreign Application Priority Data
Nov. 19, 2020 (TW) 109140622

(51) Int. Cl. H04W 72/08; H04W 24/08

(52) U.S. Cl. CPC H04W 72/085; H04W 24/08

(57) ABSTRACT

A wireless communication method is disclosed. The method includes the following operations: measuring a plurality of quality parameters of a channel between a user device and a base station device by a processor; determining a corresponding coverage enhancement (CE) level of a plurality of CE levels corresponding to the channel according to a reference signal receiving power (RSRP) parameter, an interference parameter and at least one of a bit error rate (BER) parameter and a block error rate (BLER) parameter of the plurality of quality parameters by the processor; and allocating a resource according to the corresponding CE level, for the user device to perform a first data uplink operation through the channel to uplink data to the base station device by the processor.

### CROSS-REFERENCE TO RELATED APPLICATION

This application claims the priority benefit of TAIWAN Application serial no. 109140622, filed Nov. 19, 2020, the full disclosure of which is incorporated herein by reference.

### BACKGROUND

### Field of Invention

The invention relates to a wireless communication method, a base station device and a base station system. More particularly, the invention relates to a wireless communication method, a base station device and a base station system corresponding to the coverage enhancement (CE) level.

### Description of Related Art

In narrowband Internet of Things (NB-IoT) or LTE-based Internet of Things technology (eMTC), CE levels are divided into several levels. For example, between the base station and the user device of the NB-IoT, the corresponding message retransmission times are selected according to the coverage enhancement (CE) level. When the CE level is selected, if only the distance, the signal-to-noise ratio, the reference signal received power, etc. are used for determination, it is not enough to reflect the actual channel quality. When the CE level is not properly allocated, it will cause high transmission error rate or waste many wireless resources.

### SUMMARY

An aspect of this disclosure is to provide a wireless communication method. The wireless communication method includes the following operations: measuring a plurality of quality parameters of a channel between a user device and a base station device by a processor; determining a corresponding coverage enhancement (CE) level of a plurality of CE levels corresponding to the channel according to a reference signal receiving power (RSRP) parameter, an interference parameter and at least one of a bit error rate (BER) parameter and a block error rate (BLER) parameter of the plurality of quality parameters by the processor; and allocating a resource according to the corresponding CE level, for the user device to perform a first data uplink operation through the channel to uplink data to the base station device by the processor.

Another aspect of this disclosure is to provide a base station device. The base station device includes a processor. The processor is configured to measure a plurality of quality parameters of a channel between a user device and the base station device, and to determine a corresponding CE level of a plurality of CE levels corresponding to the channel according to a RSRP parameter, an interference parameter, and at least one of a BER parameter and a BLER parameter of the plurality of quality parameters.

Another aspect of this disclosure is to provide a a base station system. The base station system includes a base station device, and a back-end intelligent control system. The back-end intelligent control system includes a processor. The processor is coupled to the base station device, and the processor is further configured to measure a plurality of quality parameters of a channel between a user device and the base station device, and the processor is further configured to determine a corresponding CE level of a plurality of CE levels corresponding to the channel according to a RSRP parameter, an interference parameter, and at least one of a BER parameter and a BLER parameter of the plurality of quality parameters.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating CE levels according to some embodiments of the present disclosure.

FIG. 2 is a schematic diagram illustrating CE levels according to some embodiments of the present disclosure.

FIG. 3 is a schematic diagram illustrating a base station device according to some embodiments of the present disclosure.

FIG. 4 is a schematic diagram illustrating a base station system according to some embodiments of the present disclosure.

FIG. 5 is a schematic diagram illustrating a base station system according to some embodiments of the present disclosure.

FIG. 6 is a flowchart of a wireless communication method according to some embodiments of the present disclosure.

FIG. 7 is a flowchart of an operation method of one of the operations is

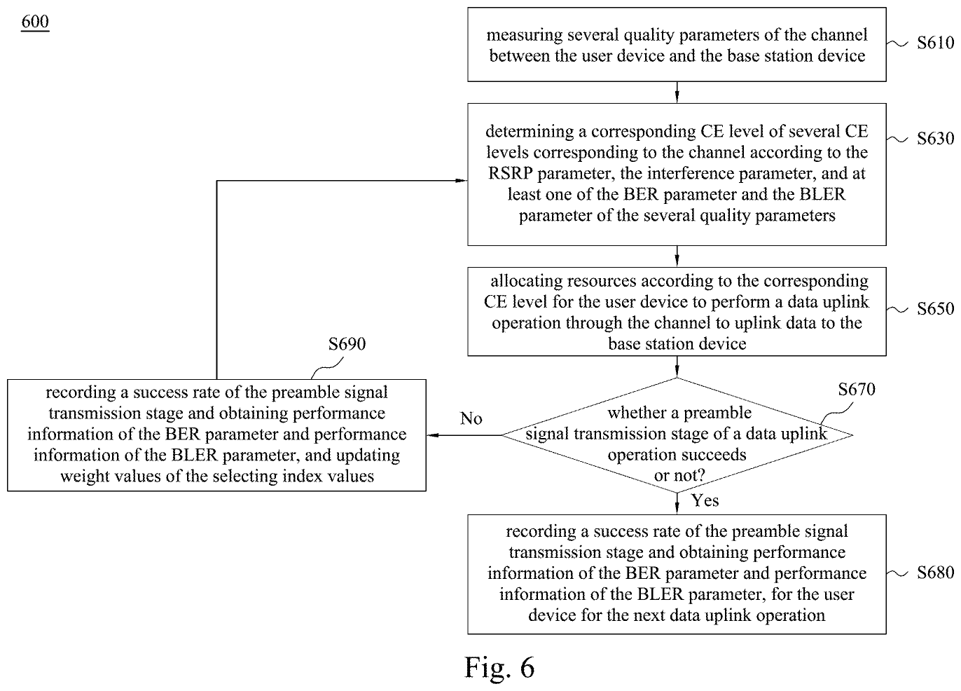

FIG. 6 according to some embodiments of the present disclosure.

FIG. 8 is a flowchart of an operation method of one of the operations is

FIG. 6 according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

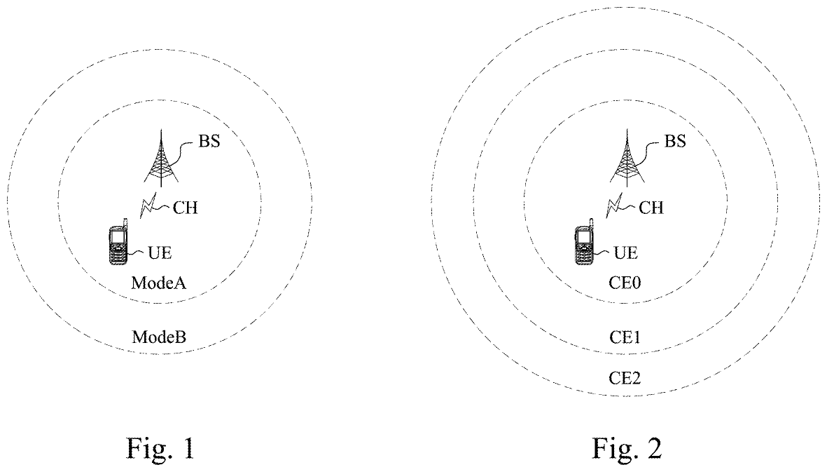

Reference is made to FIG. 1. FIG. 1 is a schematic diagram illustrating coverage enhancement levels (CE level) according to some embodiments of the present disclosure. As illustrated in FIG. 1, in the LTE-based Internet of Things (eMTC) system, the CE levels include Mode A and Mode B. Mode A refers to the situation that the distance or the channel quality is good, and many repeated transmissions are not in need. Mode B refers to the situation that the distance or channel quality is poor, and more repeated transmissions are in need.

Reference is made to FIG. 2. FIG. 2 is a schematic diagram illustrating CE levels according to some embodiments of the present disclosure. As illustrated in FIG. 2, in the Narrowband Internet of Things (NB-IOT) system, the CE levels include CE0, CE1 and CE2. CE0 is a situation that the distance or the channel quality is better, and too many repeated transmissions are not in need. CE1 is a situation that the distance or the channel quality is inferior, and some repeated transmissions are in need. CE2 is a situation that the distance or the channel quality is poor and several repeated transmissions are in need. For example, in some embodiments, CE0 corresponds to the maximum radio link loss of 144 dB, CE1 corresponds to the maximum radio link loss of 154 dB, and CE2 corresponds to the maximum radio link loss of 164 dB.

As illustrated in FIG. 1 and FIG. 2, in some embodiments, the CE level is a classification of the channel quality of the channel CH between the user device UE and the base station device BS.

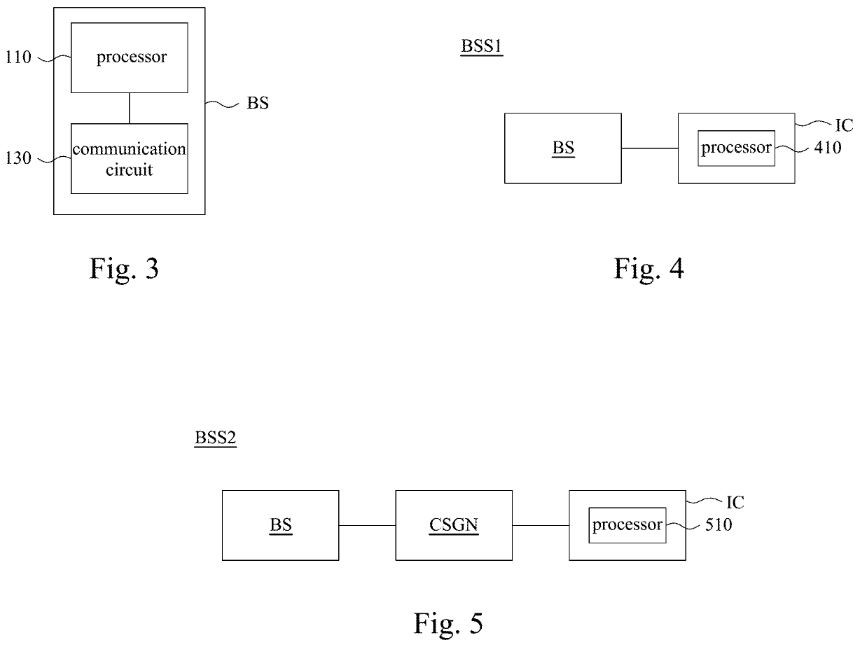

Reference is made to FIG. 3. FIG. 3 is a schematic diagram illustrating the base station device BS as illustrated in FIG. 1 and FIG. 2 according to some embodiments of the present disclosure. As illustrated in FIG. 3, in some embodiments, the base station device BS includes the processor 110 and the communication circuit 130. In the connection relationship, the processor 110 is coupled to the communication circuit 130. In some embodiments, the communication circuit 130 is configured to receive the messages transmitted by the user device UE through the channel CH and to send messages to the user device UE through the channel CH.

Reference is made to FIG. 4. FIG. 4 is a schematic diagram illustrating a base station system BSS1 according to some embodiments of the present disclosure. As illustrated in FIG. 4, in some embodiments, the base station device BS is coupled to the back-end intelligent control system IC. The back-end intelligent control system IC includes the processor 410.

Reference is made to FIG. 5. FIG. 5 is a schematic diagram illustrating a base station system BSS2 according to some embodiments of the present disclosure. As illustrated in FIG. 5, in some embodiments, the base station device BS is coupled to the back-end intelligent control system IC through the service gateway node circuit CSGN. The back-end intelligent control system IC includes the processor 510.

The operation methods of FIG. 3 to FIG. 5 will be described with reference to FIG. 6 below.

Reference is made to FIG. 6. FIG. 6 is a flowchart of a wireless communication method 600 according to some embodiments of the present disclosure. The embodiments of the present disclosure are not limited thereto.

It should be noted that, the wireless communication method 600 can be applied to base station device BS in FIG. 3, the base station system BSS1 in FIG. 4 or the base station system BSS2 in FIG. 5 or systems with the same or similar systems. To simplify the description below, the embodiments shown in FIG. 3 to FIG. 5 will be used as an example to describe the method according to an embodiment of the present disclosure. However, the present disclosure is not limited to application to the embodiments shown in FIG. 3, FIG. 4, and FIG. 5.

It should be noted that, in some embodiments, the wireless communication method 600 may be implemented as a computer program, and the computer program is stored in a non-transitory computer readable medium, so that a computer, an electronic device, or the processor 130 in FIG. 3, the processor 410 in FIG. 4 or the processor 510 in FIG. 5 reads the recording medium and executes the operation method. The processor can be consisted by one or more wafers. The computer program can be stored in a non-transitory computer readable medium such as a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this invention pertains.

Furthermore, it should be noted that, the operations of the wireless communication method 600 mentioned in the present embodiment can be adjusted according to actual needs except for those whose sequences are specifically stated, and can even be executed simultaneously or partially simultaneously.

Furthermore, in different embodiments, these operations may also be adaptively added, replaced, and/or omitted.

Reference is made to FIG. 6. The wireless communication method 600 includes the following operations.

In operation S610, several quality parameters of the channel between the user device and the base station device is measured. In some embodiments, the operation S610 is performed by the processor 130 in FIG. 3, the processor 410 in FIG. 4 or the processor 510 in FIG. 5, so as to measure several quality parameters of the channel CH between the user device UE and the base station device BS as shown in FIG. 1 and FIG. 2.

In some embodiments, the quality parameters include the BER parameter (BER), the BLER parameter (BLER), the RSRP parameter (RSRP) and the interference parameter (Interfering). The BER parameter refers to the uplink bit error rate of the connection between the user device UE and the base station device BS. The BLER parameter refers to the uplink block error rate of the connection between the user device UE and the base station device BS. The RSRP parameter refers to the uplink signal received power of the connection between the user device UE and the base station device BS. The interference parameter refers to the uplink signal interference of the user device UE caused by the uplink signals of the connections between other user devices and the base station device BS.

In operation S630, a corresponding CE level of the several CE levels corresponding to the channel is determined according to the RSRP parameter, the interference parameter and at least one of the BER parameter and the BLER parameter of several quality parameters. In some embodiments, the operation S630 is performed by the processor 130 in FIG. 3, the processor 410 in FIG. 4 or the processor 510 in FIG. 5, so as to determine the corresponding CE level corresponding to the channel CH according to the several quality parameters obtained in operation S610.

In some embodiments, in operation S630, when the processor 130, 410 or 510 determines that the quality parameters satisfy the first condition, the second condition and the third condition, the processor 130, 410 or 510 determines that the corresponding CE level is the first CE level. On the other hand, when the processor 130, 410 or 510 determines that the quality parameters do not satisfy at least one of the first condition, the second condition and the third condition, the processor 130, 410 or 510 determines that the corresponding CE level is a second CE level of the several CE levels.

The first condition mentioning above is that the RSRP parameter is larger than the RSRP parameter threshold. The second condition is that the interference parameter is smaller than the interference parameter threshold. The third condition is the BLER parameter being smaller than the BLER parameter threshold, the BER parameter being smaller than the BER parameter threshold, or the combination thereof.

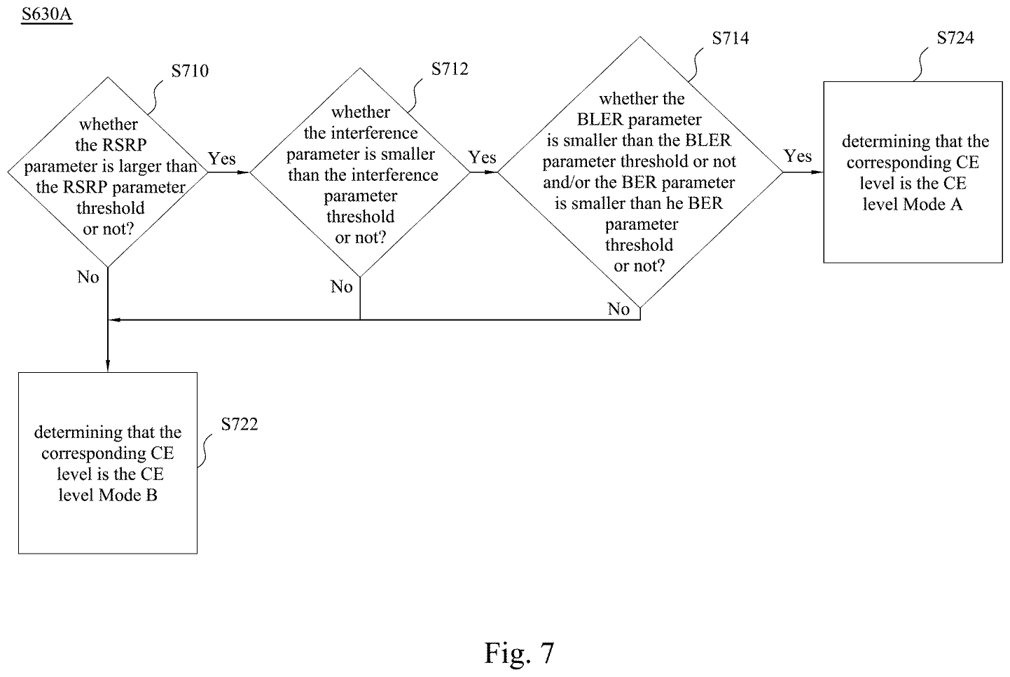

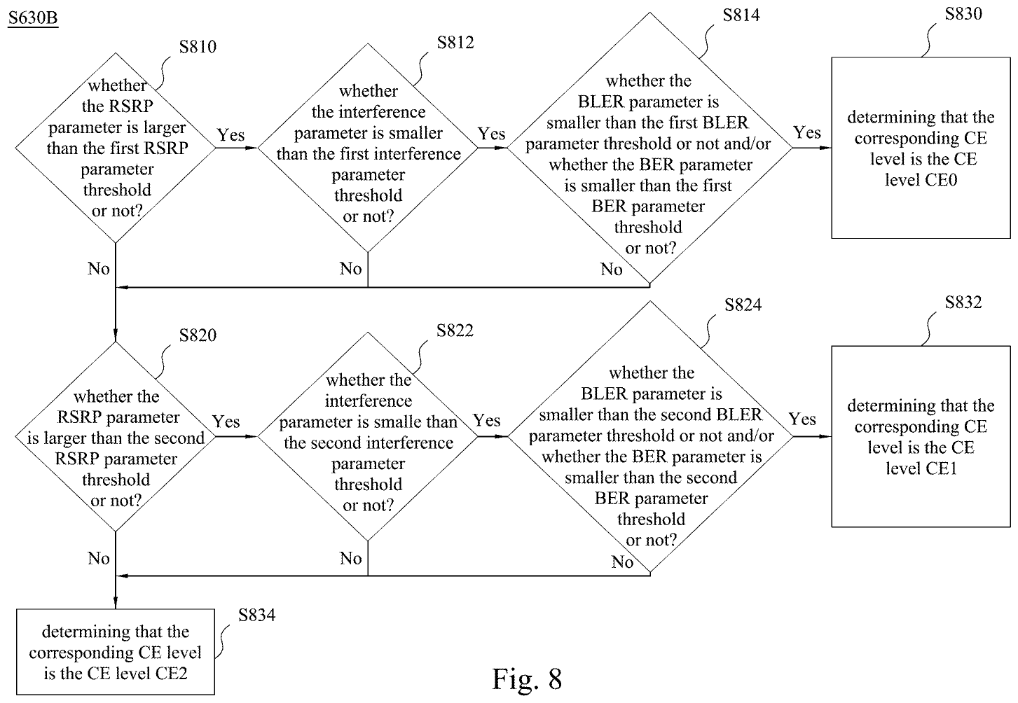

For example, reference is made to FIG. 7 together. FIG. 7 is a flowchart of an operation method 630A of operation S630 in FIG. 6 according to some embodiments of the present disclosure. The operation 630A includes the following operations.

In operation S710, whether the RSRP parameter is larger than the RSRP parameter threshold or not is determined. If the RSRP parameter is larger than RSRP parameter threshold, operation S712 is performed. On the other hand, if the RSRP parameter is not larger than the RSRP parameter threshold, operation S722 is performed.

In operation S712, whether the interference parameter is smaller than the interference parameter threshold or not is determined. If the interference parameter is smaller than the interference parameter threshold, operation S714 is performed. On the other hand, if the interference parameter is not smaller than the interference parameter threshold, operation S722 is performed.

In operation S714, whether the BLER parameter is smaller than the BLER parameter threshold or not and/or whether the BER parameter is smaller than the BER parameter threshold or not is determined. If the BLER parameter is smaller than the BLER parameter threshold and/or the BER parameter is smaller than the BER parameter threshold, operation S724 is performed. On the other hand, if the BLER parameter is not smaller than the BLER parameter threshold and/or the BER parameter is not smaller than the BER parameter threshold, operation S722 is performed.

In operation S714, the determination may be performed according to only the BER parameter or only the BLER parameter. In some other embodiments, the determination is performed according to both of the BER parameter and the BLER parameter. That is, only when the BER parameter is smaller than the BER parameter threshold and the BLER parameter is smaller than the BLER parameter threshold, the determination result of operation S714 is yes.

In operation S722, it is determined that the corresponding CE level is the CE level Mode B as illustrated in FIG. 1.

In operation S724, it is determined that the corresponding CE level is the CE level Mode A as illustrated in FIG. 1.

It should be noted that, the determination sequence of operation S710 to operation S714 shown in FIG. 7 is only for illustrative purposes, and the embodiments of the present disclosure are not limited thereto.

In some other embodiments, in operation S630, when the processor 130, 410 or 510 determines that the quality parameters satisfy the first condition, the second condition and the third condition, the processor 130, 410 or 510 determines that the corresponding CE level is the first CE level. When the processor 130, 410 or 510 determines that the quality parameter satisfy the fourth condition, the fifth condition and the sixth condition, the processor 130, 410 or 510 determines that the corresponding CE level is the second CE level of the several CE levels. When the processor 130, 410 or 510 determines that the quality parameters do not satisfy at least one of the fourth condition, the fifth condition and the sixth condition, the processor 130, 410 or 510 determines that the corresponding CE level is the third CE level.

The first condition mentioning above is that the RSRP parameter is larger than first RSRP parameter threshold. The second condition is that the interference parameter is smaller than the first interference parameter threshold. The third condition is the BLER parameter being smaller than the first BLER parameter threshold, the BER parameter being smaller than the first BER parameter threshold, or the combination thereof. The fourth condition is that the RSRP parameter is not larger than the first RSRP parameter threshold and larger than the second RSRP parameter threshold. The fifth condition is that the interference parameter is not smaller than the first interference parameter threshold and that the interference parameter is smaller than the second interference parameter. The sixth condition is the BLER parameter not being smaller than the first BLER parameter threshold and being smaller than the second BLER parameter threshold, the BER parameter not being smaller than the first BER parameter threshold and being smaller than the second BER parameter threshold, or the combination thereof.

The first RSRP parameter threshold mentioning above is larger than the second RSRP parameter threshold. The first interference parameter threshold is smaller than the second interference parameter threshold. The first BLER parameter threshold is smaller than the second BLER parameter threshold. The first BER parameter threshold is smaller than the second BER parameter threshold.

For example, reference is made to FIG. 8 together. FIG. 8 is a flowchart of an operation method 630B of operation S630 of FIG. 6 according to some embodiments of the present disclosure. The operation 630B includes the following operations.

In operation S810, whether the RSRP parameter is larger than the first RSRP parameter threshold or not is determined. If the RSRP parameter is larger than the first RSRP parameter threshold, operation S812 is performed. On the other hand, if the RSRP parameter is not larger than first RSRP parameter threshold, operation S820 is performed.

In operation S812, whether the interference parameter is smaller than the first interference parameter threshold or not is determined. If the interference parameter is smaller than the first interference parameter threshold, operation S814 is performed. On the other hand, if the interference parameter is not smaller than the first interference parameter threshold, operation S820 is performed.

In operation S814, whether the BLER parameter is smaller than the first BLER parameter threshold or not and/or whether the BER parameter is smaller than the first BER parameter threshold or not is determined. If the BLER parameter is smaller than the first BLER parameter threshold and/or the BER parameter is smaller than the first BER parameter threshold, operation S824 is performed. On the other hand, if the BLER parameter is not smaller than the first BLER parameter threshold and/or the BER parameter is not smaller than the first BER parameter threshold, operation S830 is performed.

In operation S820, whether the RSRP parameter is larger than the second RSRP parameter threshold or not is determined. If the RSRP parameter is larger than the second RSRP parameter threshold, operation S822 is performed. On the other hand, if the RSRP parameter is not larger than the second RSRP parameter threshold, operation S834 is performed.

In operation S822, whether the interference parameter is smaller than the second interference parameter threshold or not is determined. If the interference parameter is smaller than the second interference parameter threshold, operation S824 is performed. On the other hand, if the interference parameter is not smaller than the second interference parameter threshold, operation S834 is performed.

In operation S824, whether the BLER parameter is smaller than the second BLER parameter threshold or not and/or whether the BER parameter is smaller than the second BER parameter threshold or not is determined. If the BLER parameter is smaller than the second BLER parameter threshold and/or the BER parameter is smaller than second BER parameter threshold, operation S832 is performed. On the other hand, if the BLER parameter is not smaller than the second BLER parameter threshold and/or the BER parameter is not smaller than the second BER parameter threshold, operation S834 is performed.

In operation S830, it is determined that the corresponding CE level is the CE level CE0 as shown in FIG. 2.

In operation S832, it is determined that the corresponding CE level is the CE level CE1 as shown in FIG. 2.

In operation S834, it is determined that the corresponding CE level CE level CE2 as shown in FIG. 2.

In operation S814 and S824, the determination may be performed only to the BER parameter or only to the BLER parameter. In some other embodiments, the determination may be performed to both of the BER parameter and the BLER parameter. That is, only when the BER parameter is smaller than the BER parameter threshold and the BLER parameter is smaller than the BLER parameter threshold, the determination results of operation S814 and S824 are yes.

It should be noted that, the determination sequence of operation S810 to operation S834 shown in FIG. 8 is only for illustrative purposes only, and the embodiments of the present disclosure are not limited thereto.

In some other embodiments, in operation S630, the processor 130, 410 or 510 generates the selecting index value according to the RSRP parameter, the interference parameter, and at least one of the BER parameter and the BLER parameter, and the processor 130, 410 or 510 further determines the corresponding CE level according to the selecting index value.

In some embodiments, the processor 130, 410 or 510 is further configured to set the first weight value corresponding to at least one of the BER parameter and the BLER parameter, the second weight value corresponding to the RSRP parameter, and the third weight value corresponding to the interference parameter, and the processor 130, 410 or 510 generates the selecting index value according to the first weight value, the second weight value and the third weight value.

For example, in some embodiments, the selecting index value is as following:

w(i)=α·Pserving(i)+β·Pinterfered(i)+γ·BLER(i)

w(i) in the above mentioned formula refers to the selecting index value of the user device UE. Pserving(i) refers to the RSRP parameter of the user device UE. Pinterfered(i) refers to the interference parameter of the user device UE. BLER(i) refers to the BLER parameter of the user device UE. α refers to the weight value of the Pserving(i). β refers to the weight value of the Pinterfered(i). γ refers to the weight value of the BLER(i).

After calculating the selecting index value w(i), the processor 130, 410 or 510 determines the corresponding CE level according to the selecting index value w(i).

In some embodiments, when the selecting index value is larger than selecting index threshold, it is determined that the corresponding CE level is the first CE level. On the other hand, when the selecting index value is not larger than the selecting index threshold, it is determined that the corresponding CE level is the second CE level.

For example, reference is made to FIG. 1 together. In some embodiments, when the selecting index value w(i) is larger than the selecting index threshold, it is determined that the corresponding CE level of the channel CH is Mode A. On the other hand, when the selecting index value w(i) is not larger than the selecting index threshold, it is determined that the corresponding CE level of the channel CH is Mode B.

In some other embodiments, when the selecting index value is larger than a first selecting index threshold, it is determined that the corresponding CE level is the first CE level. When the selecting index value is not larger than the first selecting index threshold and is larger than the second selecting index threshold, it is determined that the corresponding CE level is the second CE level. When the selecting index value is not larger than the second selecting index threshold, it is determined that the corresponding CE level is the third CE level.

For example, reference is made to FIG. 3 together. in some embodiments, when the selecting index value w(i) is larger than the first selecting index threshold, it is determined that the corresponding CE level of the channel CH is the CE level CE0. When the selecting index value w(i) is not larger than the first selecting index threshold and is larger than the second selecting index threshold, it is determined that the corresponding CE level of the channel CH is the CE level CE1. Furthermore, when the selecting index value is not larger than the second selecting index threshold, it is determined that the corresponding CE level is the CE level CE2.

Reference is made to FIG. 6 again. In operation S650, resources are allocated according to the corresponding CE level, for the user device to perform the data uplink operation through the channel, to uplink data to the base station device. In some embodiments, the operation S650 is performed by the processor 130 in FIG. 3, the processor 410 in FIG. 4 or the processor 510 in FIG. 5, so as to allocate resources corresponding to the corresponding CE level according to the corresponding CE level determined at the operation S630, for the user device UE to perform the data uplink operation through the channel CH, to uplink data to the base station device BS.

In operation S670, whether the data uplink operation of the preamble signal transmission stage succeeds or not is determined. In some embodiments, the data uplink operation includes the preamble signal transmission stage. Operation S670 is performed by the processor 130 in FIG. 3, the processor 410 in FIG. 4 or the processor 510 in FIG. 5, so as to determine whether the preamble signal transmission stage of the data uplink operation performed by the user device UE to the base station device BS succeeds or not.

In operation S680, the success rate of the preamble signal transmission stage is recorded, to obtain performance information of the BER parameter and the performance information of the BLER parameter, for the user device to utilize during the next data uplink operation. In some embodiments, operation S680 is performed by the processor 130 in FIG. 3, the processor 410 in FIG. 4 or the processor 510 in FIG. 5.

For example, in some embodiments, the processor 130, 410 or 510 records and stores the success rate of the preamble signal transmission stage, to obtain the performance information of the BER parameter and the performance information of the BLER parameter, for the user device UE to utilize when determining the corresponding CE level during the next data uplink operation to uplink data to the base station device BS.

In operation S690, the success rate of the preamble signal transmission stage is recorded, to obtain the performance information of the BER parameter and the performance information of the BLER parameter, and the weight value of the selecting index value is updated. In some embodiments, operation S690 is performed by the processor 130 in FIG. 3, the processor 410 in FIG. 4 or the processor 510 in FIG. 5.

For example, in some embodiments, processor 130, 410 or 510 updates the weight value α, β, γ of the selecting index value w(i). In some embodiments, the weight value α, β, γ may be adjusted according to the requirements. The sum of the weight value α, β, γ should be 1. That is, α+β+γ=1.

After updating the weight value of the selecting index value, operation S630 is performed, so as to determine the corresponding CE level again according to the updated weight value.

In some embodiments, the processor 130, the processor 410 or the processor 510 may be a server or other devices. In some embodiments, the processor 130, the processor 410, or the processor 510 can be a server, a circuit, a central processing unit (CPU), or a microprocessor (MCU) or other devices with functions such as storage, calculation, data reading, signals or messages receiving, and signals or messages transmitting or other equivalent functions. In some embodiments, the communication circuit 130 may be an element or a circuit with functions of data transmitting/receiving function or other similar functions.

According to the embodiment of the present disclosure, it is understood that the embodiment of the present disclosure is to provide a wireless communication method, a base station device and a base station system, when classifying the CE level, the interference, the block error rate, and the bit error rate are all taken into consideration to actually reflect the channel quality, to effectively reduce the transmission error rate, and to improve resource utilization. After optimizing the resource utilization, the transmission volume is increased, and the number of user devices that can be served is indirectly increased.

In this document, the term “coupled” may also be termed as “electrically coupled”, and the term “connected” may be termed as “electrically connected”. “coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed, and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A wireless communication method, comprising:
measuring a plurality of quality parameters of a channel between a user device and a base station device by a processor;
determining a corresponding coverage enhancement (CE) level of a plurality of CE levels corresponding to the channel according to a reference signal receiving power (RSRP) parameter, an interference parameter and at least one of a bit error rate (BER) parameter and a block error rate (BLER) parameter of the plurality of quality parameters by the processor; and
allocating a resource according to the corresponding CE level, for the user device to perform a first data uplink operation through the channel to uplink data to the base station device by the processor.

2. The wireless communication method of claim 1, further comprising:
determining that the corresponding CE level is a first CE level of the plurality of CE levels when the processor determines that the plurality of quality parameters satisfy a first condition, a second condition and a third condition; and
determining that the corresponding CE level is a second CE level of the plurality of CE levels when the processor determines that the plurality of quality parameters do not satisfy at least one of the first condition, the second condition and the third condition;
wherein the first condition is the RSRP parameter being larger than a RSRP parameter threshold;
wherein the second condition is the interference parameter being smaller than an interference parameter threshold;
wherein the third condition is the BLER parameter being smaller than a BLER parameter threshold, the BER parameter being smaller than a BER parameter threshold, or the combination thereof.

3. The wireless communication method of claim 1, further comprising:
determining that the corresponding CE level is a first CE level of the plurality of CE levels when the processor determines that the plurality of quality parameters satisfy a first condition, a second condition and a third condition;
determining that the corresponding CE level is a second CE level of the plurality of CE levels when the processor determines that the plurality of quality parameters satisfy a fourth condition, a fifth condition and a sixth condition; and
determining that the corresponding CE level is a third CE level of the plurality of CE levels when the processor determines that the plurality of quality parameters do not satisfy at least one of the fourth condition, the fifth condition and the sixth condition;
wherein the first condition is the RSRP parameter being larger than a first RSRP parameter threshold;
wherein the second condition is the interference parameter being smaller than a first interference parameter threshold;
wherein the third condition is the BLER parameter being smaller than a first BLER parameter threshold and the BER parameter being smaller than a first BER parameter threshold, or the combination thereof;
wherein the fourth condition is the RSRP parameter not being larger than the first RSRP parameter threshold and being larger than a second RSRP parameter threshold;
wherein the fifth condition is the interference parameter not being smaller than the first interference parameter threshold and the interference parameter being smaller than a second interference parameter;
wherein the sixth condition is the BLER parameter not being smaller than the first BLER parameter threshold and being smaller than a second BLER parameter threshold, the BER parameter not being smaller than the first BER parameter threshold and being smaller than a second BER parameter threshold, or the combination thereof.

4. The wireless communication method of claim 1, further comprising:
generating a selecting index value according to the RSRP parameter, the interference parameter, and at least one of the BER parameter and the BLER parameter; and
determining the corresponding CE level according to the selecting index value.

5. The wireless communication method of claim 4, further comprising:
determining that the corresponding CE level is a first CE level of the plurality of CE levels when the selecting index value is larger than a selecting index threshold; and
determining that the corresponding CE level is a second CE level of the plurality of CE levels when the selecting index value is not larger than a selecting index threshold.

6. The wireless communication method of claim 4, further comprising:
determining that the corresponding CE level is a first CE level of the plurality of CE levels when the selecting index value is larger than a first selecting index threshold;
determining that the corresponding CE level is a second CE level of the plurality of CE levels when the selecting index value is not larger than the first selecting index threshold and is larger than a second selecting index threshold; and
determining that the corresponding CE level is a third CE level of the plurality of CE levels when the selecting index value is not larger than the second selecting index threshold.

7. The wireless communication method of claim 4, further comprising:
setting a first weight value corresponding to at least one of the BER parameter and the BLER parameter, a second weight value corresponding to the RSRP parameter, and a third weight value corresponding to the interference parameter; and
generating the selecting index value according to the first weight value, the second weight value and the third weight value.

8. The wireless communication method of claim 7, wherein the first data uplink operation comprises a preamble signal transmission stage, and the wireless communication method further comprises:
updating the first weight value, the second weight value and the third weight value when it is determined that the preamble signal transmission stage does not succeed.

9. The wireless communication method of claim 1, wherein the first data uplink operation comprises a preamble signal transmission stage, and the wireless communication method further comprises:
recording a success rate of the preamble signal transmission stage; and
obtaining performance information of the BER parameter and performance information of the BLER parameter.

10. The wireless communication method of claim 1, wireless communication method, wherein the first data uplink operation comprises a preamble signal transmission stage, and the wireless communication method further comprises:
recording a success rate of the preamble signal transmission stage, and obtaining performance information of the BER parameter and performance information of the BLER parameter for the user device to perform a second data uplink operation to uplink data to the base station device when it is determined that the preamble signal transmission stage succeeds.

11. A base station device, comprising:
a processor, configured to measure a plurality of quality parameters of a channel between a user device and the base station device, and to determine a corresponding CE level of a plurality of CE levels corresponding to the channel according to a RSRP parameter, an interference parameter, and at least one of a BER parameter and a BLER parameter of the plurality of quality parameters.

12. The base station device of claim 11, wherein when the processor determines that the plurality of quality parameters satisfy a first condition, a second condition and a third condition, the processor determines that the corresponding CE level is a first CE level of the plurality of CE levels,
wherein the first condition is the RSRP parameter being larger than a RSRP parameter threshold;
wherein the second condition is the interference parameter being smaller than an interference parameter threshold;
wherein the third condition is the BLER parameter being smaller than a BLER parameter threshold and the BER parameter being smaller than a BER parameter threshold, or the combination thereof.

13. The base station device of claim 12, wherein when the processor determines that the plurality of quality parameters do not satisfy at least one of the first condition, the second condition and the third condition, the processor determines that the corresponding CE level is a second CE level of the plurality of CE levels.

14. The base station device of claim 12, wherein when the processor determines that the plurality of quality parameters satisfy a fourth condition, a fifth condition and a sixth condition, the processor determines that the corresponding CE level is a second CE level of the plurality of CE levels; when the processor determines that the plurality of quality parameters do not satisfy at least one of a fourth condition, a fifth condition and a sixth condition, the processor determines that the corresponding CE level is a third CE level of the plurality of CE levels;
wherein the fourth condition is the RSRP parameter not being larger than a first RSRP parameter threshold and being larger than a second RSRP parameter threshold;
wherein the fifth condition is the interference parameter not being smaller than a first interference parameter threshold and the interference parameter being smaller than a second interference parameter;
wherein the sixth condition is the BLER parameter not being smaller than a first BLER parameter threshold and being smaller than a second BLER parameter threshold, the BER parameter not being smaller than a first BER parameter threshold and being smaller than a second BER parameter threshold, or the combination thereof.

15. The base station device of claim 11, wherein the processor is further configured to generate a selecting index value according to the RSRP parameter and the interference parameter, and at least one of the BER parameter and the BLER parameter, and the processor is further configured to determine the corresponding CE level according to the selecting index value.

16. The base station device of claim 15, wherein the processor is further configured to set a first weight value corresponding to at least one of the BER parameter and the BLER parameters, a second weight value corresponding to the RSRP parameter, and a third weight value corresponding to the interference parameter, and the processor is configured to generate the selecting index value according to the first weight value, the second weight value and the third weight value.

17. The base station device of claim 16, wherein a first data uplink operation comprises a preamble signal transmission stage, wherein the processor is further configured to update the first weight value, the second weight value and the third weight value when it is determined that the preamble signal transmission stage does not succeed.

18. The base station device of claim 11, wherein a first data uplink operation comprises a preamble signal transmission stage, wherein the processor is further configured to record a success rate of the preamble signal transmission stage, to obtain performance information of the BER parameter and performance information of the BLER parameter, for the user device to perform a second data uplink operation to uplink data to the base station device when it is determined that the preamble signal transmission stage succeeds.

19. A base station system, comprising:
a base station device; and
a back-end intelligent control system, comprising:
a processor, coupled to the base station device, wherein the processor is further configured to measure a plurality of quality parameters of a channel between a user device and the base station device, and the processor is further configured to determine a corresponding CE level of a plurality of CE levels corresponding to the channel according to a RSRP parameter, an interference parameter, and at least one of a BER parameter and a BLER parameter of the plurality of quality parameters.

20. The base station system of claim 19, wherein the processor is coupled to the base station device through a service gateway node circuit.
